(19) United States
(12) Patent Application Publication
(10) Pub. No.: US 2019/0362056 A1
(43) Pub. Date: Nov. 28, 2019

(54) INFORMATION PROCESSING APPARATUS, INFORMATION PROCESSING METHOD, AND PROGRAM

(71) Applicant: SONY CORPORATION, TOKYO (JP)

(72) Inventor: MASATO SHIMAKAWA, TOKYO (JP)

(21) Appl. No.: 16/473,934

(22) PCT Filed: Dec. 14, 2017
(86) PCT No.: PCT/JP2017/044986

§ 371 Date: Jun. 26, 2019

(30) Foreign Application Priority Data
Feb. 17, 2017 (JP) 2017-027471

(51) Int. Cl. G06F 21/10; G06F 3/14; G06F 21/60

(52) U.S. Cl. CPC G06F 21/105; G06F 2221/0768; G06F 21/602; G06F 3/14

(57) ABSTRACT

The present disclosure proposes an information processing apparatus, an information processing method, and a program capable of permitting or accepting content generation by a device adaptively to a context. The information processing apparatus includes: an acquisition unit that acquires context information of a device; a first determination unit that determines whether or not the device has a license for content generation according to the context information; and a processing unit that performs processing for permitting or accepting the content generation by the device in a case where it is determined that the device has the license.

### TECHNICAL FIELD

The present disclosure relates to an information processing apparatus, an information processing method, and a program.

### BACKGROUND ART

Conventionally, various technologies related to human interfaces, such as augmented reality (AR), linking the real world and the virtual world have been developed.

For example, Patent Document 1 below discloses a technology in which a display device having a glasses-type display acquires information indicating the state of the outside world from an external device. Furthermore, Patent Document 2 below discloses a technology of changing a display range of a video displayed on a head mounted display (HMD) according to a detection result of a posture of a head portion of a user wearing the HMD, when free-viewpoint content is displayed on the HMD.

### CITATION LIST

### Patent Document

### Patent Document 1: Japanese Patent Application Laid-Open No. 2015-46885

### Patent Document 2: Japanese Patent Application Laid-Open No. 2016-25633

### SUMMARY OF THE INVENTION

### Problems to be Solved by the Invention

By the way, there is a case where it is desirable that content generation by a device is permitted or restricted. Assuming that the technology disclosed in Patent Document 1 or Patent Document 2 is applied to such a scene, these technologies permit or restrict fixedly the content generation by a device regardless of the situation.

Thus, the present disclosure proposes a new and improved information processing apparatus, information processing method, and program capable of permitting or accepting content generation by a device adaptively to a context.

### Solutions to Problems

According to the present disclosure, provided is an information processing apparatus including: an acquisition unit that acquires context information of a device; a first determination unit that determines whether or not the device has a license for content generation according to the context information; and a processing unit that performs processing for permitting or accepting the content generation by the device in a case where it is determined that the device has the license.

Furthermore, according to the present disclosure, provided is an information processing method including: acquiring context information of a device; determining whether or not the device has a license for content generation according to the context information; and performing, by a processing unit, processing for permitting or accepting the content generation by the device in a case where it is determined that the device has the license.

Furthermore, according to the present disclosure, provided is a program for causing a computer to function as: an acquisition unit that acquires context information of a device; a first determination unit that determines whether or not the device has a license for content generation according to the context information; and a processing unit that performs processing for permitting or accepting the content generation by the device in a case where it is determined that the device has the license.

### Effects of the Invention

As described above, according to the present disclosure, content generation by a device can be permitted or accepted adaptively to a context. Note that the effects described herein are not necessarily limited, and any of the effects described in the present disclosure may be applied.

### BRIEF DESCRIPTION OF DRAWINGS

FIG. 1 is an explanatory diagram showing a configuration example of an information processing system according to an embodiment of the present disclosure.

FIG. 2 is an explanatory diagram showing a relationship between a business license, an owner license, and content according to the same embodiment.

FIG. 3 is an explanatory diagram showing a configuration example of the business license according to the same embodiment.

FIG. 4 is an explanatory diagram showing a specific example of types of functions permitted by the business license or the owner license.

FIG. 5 is a functional block diagram showing a configuration example of a server 10 according to the same embodiment.

FIG. 6A is an explanatory diagram showing an example of a method of determining the validity of a user device 20 according to the same embodiment.

FIG. 6B is an explanatory diagram showing an example of the method of determining the validity of the user device 20 according to the same embodiment.

FIG. 7 is an explanatory diagram showing an example of the method of determining the validity of the user device 20 according to the same embodiment.

FIG. 8 is an explanatory diagram showing an example of the method of determining the validity of the user device 20 according to the same embodiment.

FIG. 9 is a functional block diagram showing a configuration example of the user device 20 according to the same embodiment.

FIG. 10 is a sequence diagram showing a part of “a flow of processing at the time of determination of the validity of the user device 20” according to the same embodiment.

FIG. 11 is a sequence diagram showing a part of “the flow of processing at the time of determination of the validity of the user device 20” according to the same embodiment.

FIG. 12 is a sequence diagram showing “a flow of content generation processing” according to the same embodiment.

FIG. 13 is a sequence diagram showing “a flow of processing in using content” according to the embodiment.

FIG. 14A is an explanatory diagram showing types of functions permitted by the business license for a content creator according to an application example 1 of the same embodiment.

FIG. 14B is an explanatory diagram showing types of functions permitted by the business license for content users according to the application example 1.

FIG. 15A is an explanatory diagram showing types of functions permitted by the business license for a content creator according to an application example 2 of the same embodiment.

FIG. 15B is an explanatory diagram showing types of functions permitted by the business license for content users according to the application example 2.

FIG. 16A is an explanatory diagram showing types of functions permitted by the business license for a content creator according to an application example 3 of the same embodiment.

FIG. 16B is an explanatory diagram showing types of functions permitted by the business license for content users according to the application example 3.

FIG. 17A is an explanatory diagram showing types of functions permitted by the business license for a content creator according to an application example 4 of the same embodiment.

FIG. 17B is an explanatory diagram showing types of functions permitted by the business license for content users according to the application example 4.

FIG. 18 is a configuration diagram showing a hardware configuration of the server 10 according to the same embodiment.

### MODE FOR CARRYING OUT THE INVENTION

Preferred embodiments of the present disclosure will be described in detail below with reference to the accompanying drawings. Note that, in the present specification and the drawings, the same reference numerals are given to the constituent elements having substantially the same functional configuration, and redundant explanations are omitted.

Furthermore, in this specification and the drawings, a plurality of constituent elements having substantially the same functional configuration may be distinguished by attaching different alphabets after the same reference numerals. For example, a plurality of constituent elements having substantially the same functional configuration is distinguished like the user device 20a and the user device 20b as necessary. However, in a case where it is not necessary to particularly distinguish each of a plurality of constituent elements having substantially the same functional configuration, only the same reference numerals are attached. For example, the user device 20a and the user device 20b are simply referred to as the user device 20 in a case where it is not necessary to distinguish them.

Furthermore, the “mode for carrying out the invention” will be described according to the order of items shown below.

1. Configuration of Information Processing System

2. Detailed Description of Embodiment

3. Hardware Configuration

4. Modification

### 1. Configuration of Information Processing System

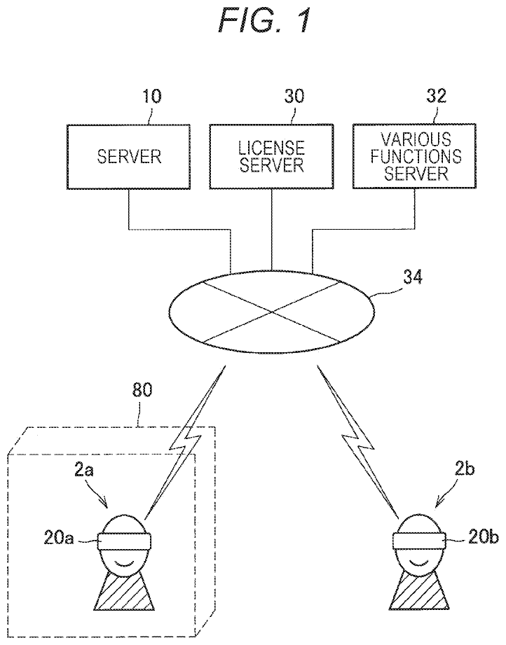

First, a configuration example of an information processing system according to an embodiment of the present disclosure will be described with reference to FIG. 1. As shown in FIG. 1, in the present embodiment, it is assumed that a user 2 having a user device 20 enters or exits from a predetermined region 80 (in real space). Here, the region 80 may be a region where a predetermined business operator has temporary or continuous management authority. For example, the region 80 is a theme park, a cinema, an art museum, a museum, a commercial building, an office building, a school, a train station, an airport, or the like.

### 1-1. Background

By the way, if the use of a device by a general user is permitted unlimitedly in the region 80, the profit of the business operator may be lost. For example, in some cases, the business operator desires to restrict video shooting by a general user in the region 80, distribution of the video shot, and the like. In particular, for devices that are supposed to be worn by the user all the time, such as AR glasses, for example, the business operator may desire to further restrict the use of these devices, as it is difficult to check the usage status.

Note that a method may also be considered in which the use of the device by a general user in the region 80 is completely prohibited. However, this method greatly impairs the convenience of the user. Therefore, a method of maximizing the profit of both the business operator and the general user is desired.

Therefore, with the above circumstances as one point of view, a server 10 according to the present embodiment has created. The server 10 according to the present embodiment acquires context information of a user device 20, determines whether or not the user device 20 has a license for content generation according to the context information, and performs processing for permitting or allowing the user device 20 to generate the content in a case where it is determined that the user device 20 has the license. For this reason, content generation by the user device 20 can be adaptively permitted or allowed depending on the situation.

Here, the context information is information indicating a specific context (specifically, a specific location, a specific date and time (or a period) or the like). Specific examples of the context include movie showtimes at movie theaters, school athletic events, and the like.

For example, the context information includes location information indicating a location corresponding to the context, and/or date and time information indicating a date and time (or a period) corresponding to the context. Alternatively, the context information includes, for example, a context ID uniquely associated with the context indicated by the context information. Note that the context ID may be the same ID at the same location, or the ID may be switched depending on the date and time at the same location. Furthermore, an expiration date may or may not be set for the context ID.

As shown in FIG. 1, the information processing system according to the present embodiment includes the server 10, the user device 20, a license server 30, various functions server 32, and a communication network 34.

### 1-2. User Device 20

The user device 20 is a device carried by the user 2 (for example, a general user, or the like). For example, the user device 20 may be a camera, a microphone, a mobile phone such as a smartphone, a tablet terminal, a portable music player, or a head-mounted wearable device such as an AR glass or an HMD.

The user device 20 has a sensor unit 226 as described later. A sensor unit 226 senses, for example, video, audio, other types of data, or the like.

Furthermore, the user device 20 can also communicate with other devices via a communication network 34 as described later. For example, one user device 20a transmits various types of information to another user device 20b via the communication network 34.

For example, the user device 20a may be a head-mounted wearable device. Then, the user device 20a can transmit a surrounding video (such as an omnidirectional video) shot by a plurality of imaging units (included in the sensor unit 226), for example, in real time, to another user device 20b located at a remote place (hereinafter, this may be referred to as space sharing), and furthermore, the user device 20b can display the video in real time. As a result, the user 2 who uses the user device 20b can experience as if he/she were inside the space corresponding to the video. Note that as a specific method for realizing space sharing, for example, the technology disclosed in WO 2015/122108 may be used.

### 1-3. Server 10

The server 10 is an example of an information processing apparatus according to the present disclosure. The server 10 is a device for performing processing regarding permission or acceptance regarding content generation by the user device 20. Here, content generation also includes live streaming.

Note that although only one server 10 is shown in FIG. 1, it is not limited to this example, and a plurality of computers may cooperatively operate to realize the functions of the server 10 according to the present embodiment.

### 1-4. Various Functions Server 32

The various functions server 32 is a device that provides various services to the other device on the basis of a request received from the other device (for example, the user device 20, or the like). For example, the various functions server 32 provides a recognition service, a recording service, a distribution service, a social networking service (SNS) service, or the like. Note that the various functions server 32 may provide a plurality of types of services (independently), or separate devices may be installed (as various functions server 32) for each service to be provided.

Here, the recognition service is a service for receiving content (for example, video (such as 2D video and 3D video), audio data, or the like) from the other device, performing recognition processing on the content, and transmitting the result of the recognition processing to the other device. Furthermore, the recording service is a service for receiving content from another device and recording the content in a database. Furthermore, the distribution service is a service for receiving content from a certain device (such as the user device 20a), and distributing the content to at least one other device (such as the user device 20b). Furthermore, the SNS service is a service for managing a predetermined SNS. For example, in the SNS service, a plurality of users 2 can share content uploaded by a certain user 2a.

### 1-5. License Server 30

The license server 30 is a device that generates content and manages a license related to the use of the generated content. Specifically, the license server 30 manages a business license issued by a business operator in association with a context ID, and an owner license issued by a content creator (such as the user 2 of the user device 20). For example, the license server 30 manages the business license and the owner license in association with the context ID and the content ID, respectively. Here, the content ID is, for example, identification information uniquely assigned to the generated content. Note that the business license is an example of a license in the present disclosure, and furthermore, the owner license is an example of a sub-license in the present disclosure.

For example, in a case where a license issuance request is received from the user device 20, the license server 30 first extracts the business license and the owner license corresponding to the context ID and the content ID included in the license issuance request from a predetermined database. Then, the license server 30 issues (provides) the extracted business license and owner license to the user device 20.

Note that business license of each of a plurality of business operators may be registered in the license server 30. In this case, the location and the business operator corresponding to the context ID may be further associated with each other, and registered in the license server 30. As a result, the business operator corresponding to the specific location can be identified in the license server 30. Alternatively, the license server 30 may be individually provided for each business operator. In this case, each license server 30 stores the business license of the business operator that manages the license server 30.

### 1-5-1. Business License/Owner License

Here, each of the business license and the owner license may be information defining the handling of the content associated with the corresponding license. Specifically, the business license is a license that indicates the type of function permitted to the user device 20 by the business operator with regard to the content associated with the business license. Furthermore, the owner license is a license that indicates the type of function permitted to the user device 20 by the user 2 who is the issuer of the owner license with respect to the content associated with the owner license.

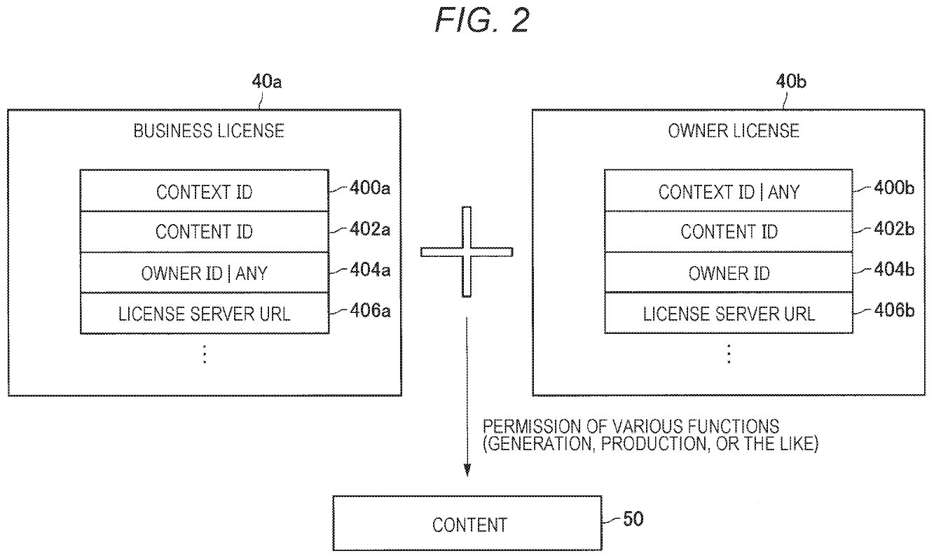

More specifically, as shown in FIG. 2, only in a case where the user device 20 has a business license and the owner license corresponding to the content for each content, the execution of the function for the content may be permitted to the user device 20. That is, in a case where the user device 20 has only one of the business license and the owner license, the execution of the function related to the content is not permitted to the user device 20. Furthermore, for each content, the execution of only the product set (in other words, the AND condition) of functions permitted by the business license and the owner license corresponding to the content may be permitted to the user device 20.

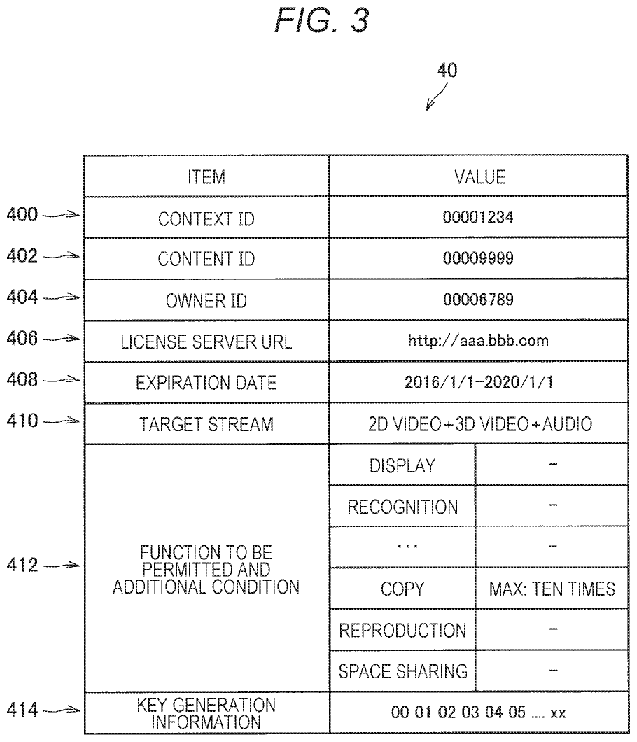

Here, with reference to FIG. 3, a configuration example of the business license and the owner license will be described. FIG. 3 is an explanatory diagram showing a configuration example (business license 40) of the business license. Note that the format of the business license and the owner license may be the same.

As shown in FIG. 3, for example, the business license 40 includes a context ID 400, content ID 402, owner ID 404, license server URL 406, expiration date 408, target stream 410, function type/additional condition 412, and key generation information 414. Here, the owner ID 404 stores the ID of the user 2 (who is the creator of the corresponding content). Furthermore, in the license server URL 406, a uniform resource locator (URL) of the license server 30 is stored. Furthermore, the expiration date of the business license 40 is stored in the expiration date 408. Note that the expiration date may not necessarily be set for the business license. Furthermore, in the target stream 410, the type of content (for example, “video”, “audio”, or the like) permitted by the corresponding business license 40 is stored. Furthermore, in the function type/additional condition 412, the type of function permitted by the corresponding business license 40 and the additional condition for each permitted function are stored. Here, the additional condition is the content of the condition defined for the execution of the corresponding function. For example, in the example shown in FIG. 3, it is set as the additional condition that “copy” can be executed for up to “ten times”. Furthermore, the key generation information 414 stores key generation information given to the corresponding business license 40. Here, the key generation information may be generated by a predetermined encryption algorithm on the basis of, for example, the context ID, the content ID, and the owner ID. Note that, in the business license, a value may not be set in the owner ID, and furthermore, in the owner license, a value may not be set in the context ID.

Note that the type of function permitted by the business license may be preset by the business operator, for example, in association with the range of values of the context ID. As an example, in a case where the context ID is in a range of “00000000” to “00000099”, the type of function may be set by the business operator as, for example, only “display”, “recognition” and “recognition service” are permitted by the business license.

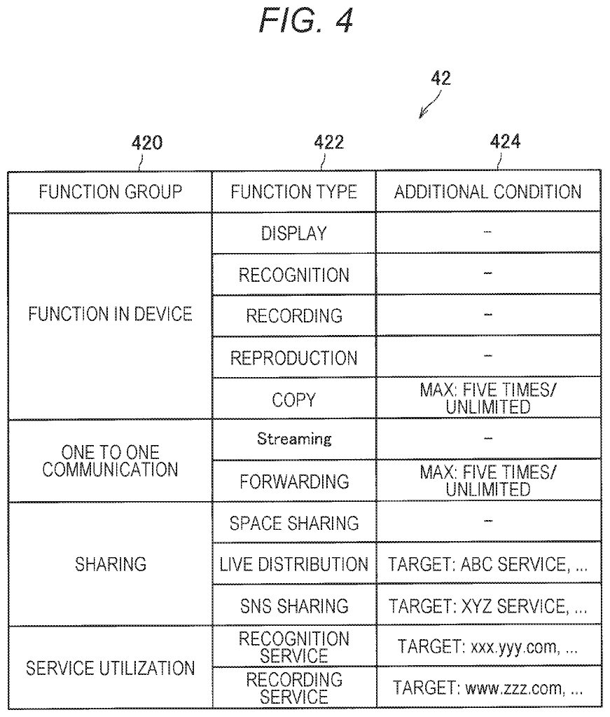

FIG. 4 is an explanatory diagram showing a specific example of types of functions permitted by the business license and the owner license, and the additional condition. As shown in FIG. 4, functions (for example, “display”, “recognition”, “recording”, “reproduction”, “replication”, or the like) executed in the user device 20 having the corresponding license, functions related to one to one communication (for example, “streaming”, “transfer” or the like), functions related to data sharing with other devices (for example, “space sharing”, “live distribution”, “SNS sharing”, or the like), and services that can be requested to the various functions server 32 (for example, “recognition service”, “recording service” or the like) and the like may be permitted by the business license or the owner license.

### 1-5-2. Content

Next, the content of the content will be described in detail. Content may be data (such as video, audio, or other types of sensor data) sensed by a device (such as user device 20) under a certain context. Note that data (within the user device 20) immediately after being sensed by the user device 20 may also be treated as content. For example, data sensed by the user device 20 and before being transferred to the recording medium, data sensed by the user device 20 and before being transmitted to another device, or the like may also be treated as the content. That is, the restriction by the business license and the owner license may be applied even when the function for the data is executed in the user device 20 that has sensed the data. Note that the content and the context ID may be associated, for example, by the user device 20 that has generated the content.

Furthermore, the content may store information for acquiring the business license and the owner license (hereinafter, referred to as license acquisition information). Here, the license acquisition information includes, for example, a context ID, a content ID, an owner ID, and link information (URL and the like) of the license server 30. For example, the content includes a descriptor and a data unit, and the license acquisition information is stored in the descriptor. Furthermore, the data unit may be encrypted using a content key generated on the basis of the business license and the owner license. This may ensure that the user device 20 cannot execute the function on the content unless the user device 20 has both the business license and the owner license corresponding to a certain content.

Although the details will be described later, for example, a predetermined function for key generation is used with the context ID, device ID, content ID, owner ID, first key generation information, and second key generation information as parameters to generate the content key. Here, the first key generation information is key generation information included in the business license, and the second key generation information is key generation information included in the owner license. Note that the predetermined function may be implemented securely in the user device 20 as highly confidential information.

Furthermore, the user device 20 can decrypt the encrypted content on the basis of the business license and the owner license. For example, when the (encrypted) content is provided to the user device 20, the user device 20 first reads out the license acquisition information from the content, and then transmits the license acquisition request including the license acquisition information to the license server 30 to acquire the business entity license and the owner license corresponding to the license acquisition request. Next, the user device 20 acquires the content key on the basis of the first key generation information included in the acquired business license, the second key generation information included in the acquired owner license, and the predetermined function. Then, the user device 20 decrypts the corresponding content using the acquired content key.

### 1-6. Communication Network 34

The communication network 34 is a wired or wireless transmission path of information transmitted from a device connected to the communication network 34. For example, the communication network 34 may include a public network such as a telephone network, the Internet, or a satellite communication network, various local area network (LAN) including Ethernet (registered trademark), a wide area network (WAN), or the like. Furthermore, the communication network 34 may include a dedicated network such as an Internet protocol-virtual private network (IP-VPN).

### 2. Detailed Description of Embodiment

### 2-1. Configuration

### 2-1-1. Server 10

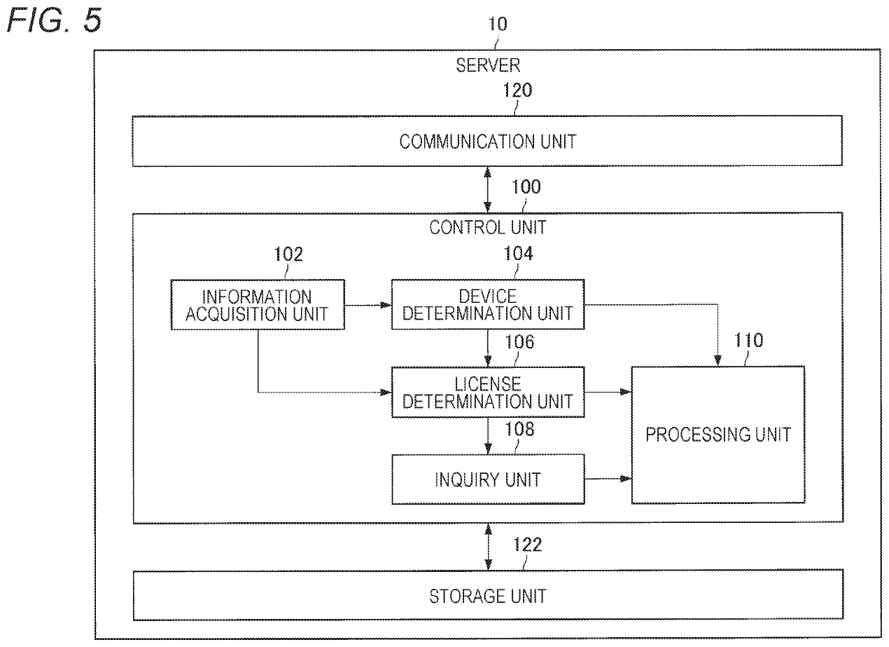

The configuration of the information processing system according to the present embodiment has been described above. Next, the configuration according to the present embodiment will be described in detail. First, the configuration of the server 10 according to the present embodiment will be described. FIG. 5 is a functional block diagram showing a configuration example of the server 10 according to the present embodiment. As shown in FIG. 5, the server 10 includes a control unit 100, a communication unit 120, and a storage unit 122.

### 2-1-1-1. Control Unit 100

The control unit 100 may include, for example, a processing circuit such as a central processing unit (CPU) 150 as described later. The control unit 100 comprehensively controls the operation of the server 10. Furthermore, as shown in FIG. 5, the control unit 100 includes an information acquisition unit 102, a device determination unit 104, a license determination unit 106, an inquiry unit 108, and a processing unit 110.

### 2-1-1-2. Information Acquisition Unit 102

The information acquisition unit 102 is an example of an acquisition unit in the present disclosure. The information acquisition unit 102 acquires context information of the user device 20. For example, the information acquisition unit 102 causes the communication unit 120 as described later to transmit a context information acquisition request to the user device 20 to acquire context information from the user device 20. Alternatively, the information acquisition unit 102 may receive the detection result of the location where the user device 20 is currently located from another device, and then, acquire context information corresponding to the detection result as context information of the corresponding user device 20.

### 2-1-1-3. Device Determination Unit 104

The device determination unit 104 is an example of a second determination unit in the present disclosure. The device determination unit 104 determines whether or not the user device 20 is a valid device on the basis of the detection result of the signal transmitted by the user device 20.

### Determination Example 1

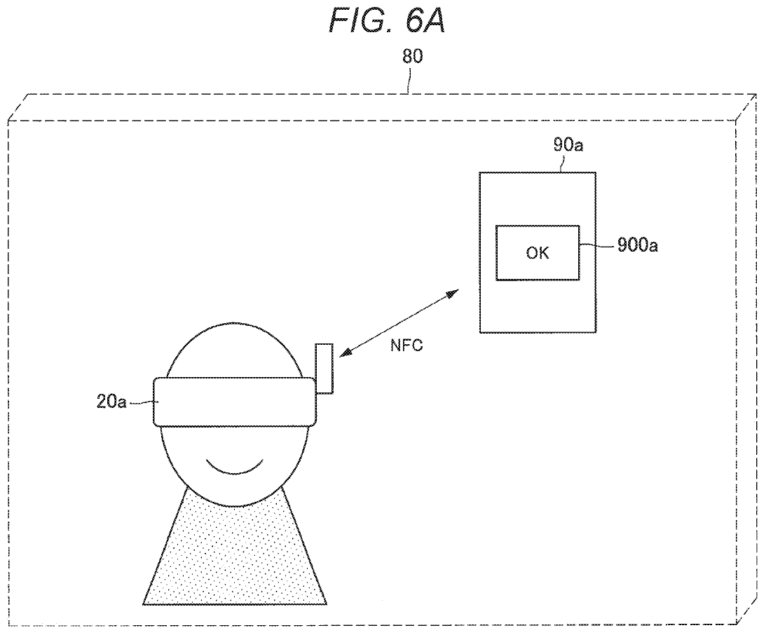

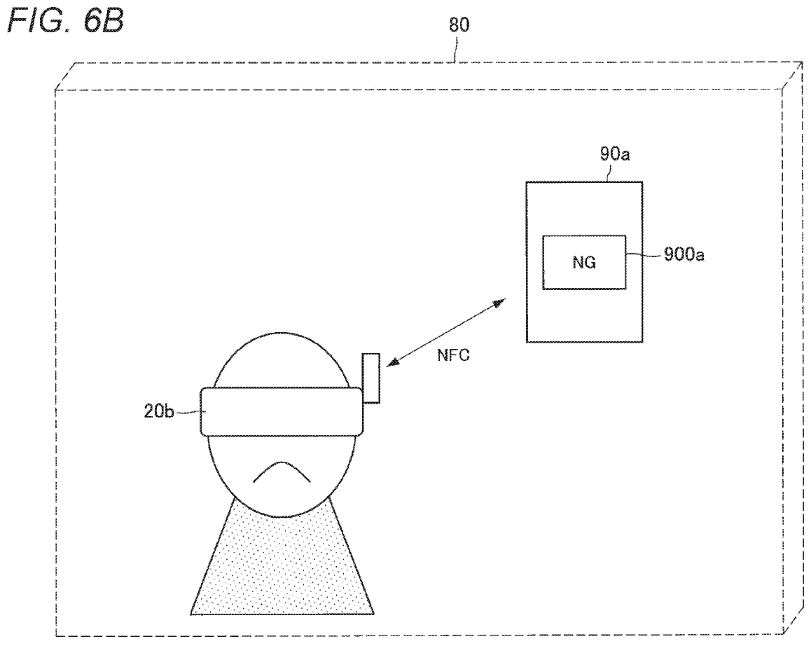

For example, as shown in FIGS. 6A and 6B, a device detection device 90a capable of communication by near field communication (NFC) may be installed in the region 80, for example. Furthermore, for example, when the user 2 carrying the user device 20 enters or exits from the region 80, the device detection device 90a may transmit a device determination request to the user device 20 by NFC. In this case, the device determination unit 104 determines whether or not the user device 20 is a valid device on the basis of the result of whether or not the device detection device 90a receives a valid response corresponding to the device determination request from the user device 20 by NFC within a predetermined time after the device determination request is transmitted.

For example, in a case where the device detection device 90 receives a valid response from the user device 20 within the predetermined time after the device determination request is transmitted, the device determination unit 104 determines that the user device 20 is a valid device. Furthermore, in a case where the device detection device 90 receives an invalid response from the user device 20 within the predetermined time after the device determination request is transmitted, or in a case where the device detection device 90 does not respond at all within the predetermined time, the device determination unit 104 determines that the user device 20 is not a valid device.

### Determination Example 2

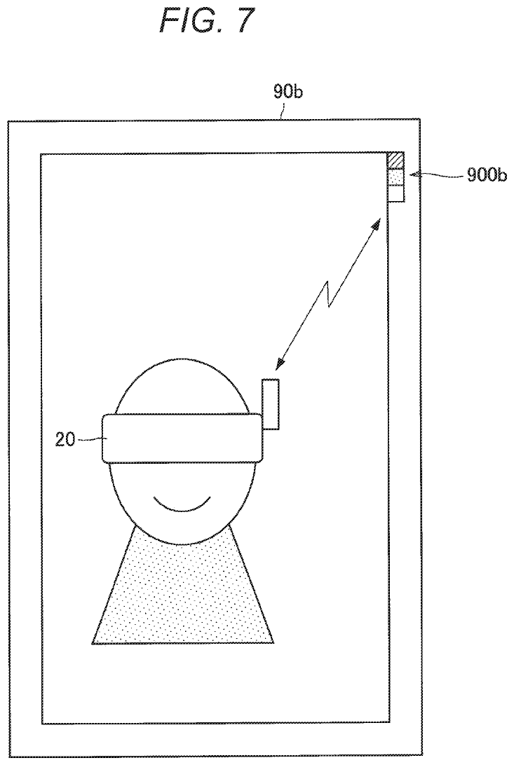

Furthermore, as shown in FIG. 7, for example, a gate-type device detection device 90b may be installed in the region 80 at the entrance of the region 80 or the like. The device detection device 90b may transmit a signal of a device determination request (for example, radio wave (wireless communication), light, audio, or the like), for example, in a case where the user device 20 is located within a predetermined distance from the device detection device 90b (for example, when the user 2 passes, or the like). In this case, the device determination unit 104 determines whether or not the user device 20 is a valid device on the basis of the result of whether or not the device detection device 90b receives a valid response corresponding to the device determination request from the user device 20 within a predetermined time after the device detection device 90b transmits the device determination request.

### Determination Example 3

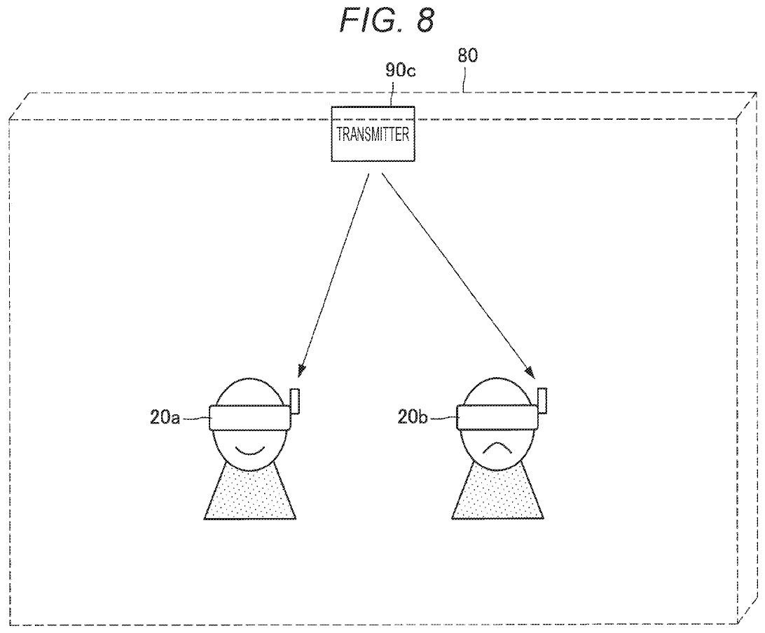

Furthermore, as shown in FIG. 8, the device detection device 90c may be installed in the region 80 such that the signal (for example, radio waves (wireless communication), light, audio, or the like) transmitted by the device detection device 90c reaches a wide region in the region 80 (for example, the device detection device 90c may be installed on a ceiling within the region 80). In this case, the device determination unit 104 can collectively determine whether or not the plurality of user devices 20 are valid on the basis of the detection results of the responses from the plurality of user devices 20 in the region 80 corresponding to the signal transmitted from the device detection device 90c.

For example, the device determination unit 104 determines whether or not the plurality of user devices 20 are valid devices on the basis of whether or not the detection result that each of the plurality of user devices 20 emits light in the same pattern as the predetermined blinking pattern is received from the device detection device 90 within a predetermined time after the device detection device 90c emits light in the predetermined blinking pattern. Here, the predetermined blinking pattern may be changed to another pattern for each light emission. This can prevent a device that is not valid from mimicking the same operation as the valid device.

Note that invisible light (such as infrared light) may be used as the type of signal. In this case, there is an advantage that the light emission pattern is not perceived by the user 2 in the region 80 (including the user 2 who is using the valid user device 20). For example, at a scene such as a movie showing at a movie theater, the legitimacy of the user device 20 can be determined without impairing the convenience of the user.

Note that, with respect to the user device 20 determined not to be a valid device, use of the user device 20 can be restricted manually (for example, confiscated or bringing into region 80 is prohibited) by notifying an agent in the region 80.

### 2-1-1-4. License Determination Unit 106

The license determination unit 106 is an example of a first determination unit in the present disclosure. The license determination unit 106 determines whether or not the user device 20 has the business license and the owner license corresponding to the context information acquired by the information acquisition unit 102. For example, the license determination unit 106 first causes the communication unit 120 to transmit an inquiry about the presence or absence of the business entity license and the owner license to, for example, the user device 20 determined to be a valid device. Then, the license determination unit 106 determines whether or not the user device 20 has the business license and the owner license on the basis of the response to the inquiry received from the user device 20.

### 2-1-1-5. Inquiry Unit 108

In a case where the license determination unit 106 determines that the user device 20 does not have the business license or the owner license, the inquiry unit 108 issues an inquiry as to whether or not to acquire the business license or the owner license for the user device 20.

### 2-1-1-6. Processing Unit 110

The processing unit 110 performs processing for permitting or accepting the content generation by the user device 20 on the basis of the determination result by the device determination unit 104 and the determination result by the license determination unit 106.

For example, in a case where the device determination unit 104 determines that the user device 20 is a valid device, the processing unit 110 performs processing for permitting or accepting the content generation by the user device 20 on the basis of the determination result by the license determination unit 106. As one example, in a case where it is determined that the user device 20 is a valid device, and it is determined that the user device 20 has the business license and the owner license, the processing unit 110 performs processing for permitting or accepting the content generation by the user device 20. Furthermore, in a case where it is determined that the user device 20 does not have the business license or the owner license, the processing unit 110 performs processing for prohibiting or restricting the content generation by the user device 20. Alternatively, in a case where it is determined that the user device 20 does not have the business license or the owner license, the processing unit 110 may cause the communication unit 120 to transmit to the user device 20 link information to the license server 30 on the basis of the response to the inquiry by the inquiry unit 108. For example, in a case where the response to the inquiry indicates that the acquisition of the business license or the owner license is desired, the processing unit 110 causes the communication unit 120 to transmit to the user device 20 the link information to the license server 30.

Furthermore, in a case where the device determination unit 104 determines that the user device 20 is not a valid device, the processing unit 110 performs processing for prohibiting or restricting the content generation by the user device 20.

### Permission or Acceptance of Content Generation

Here, the specific content of the “processing for permitting or accepting content generation” will be described. For example, the processing for permitting or accepting the content generation may include causing the display unit to display a display indicating that the content generation is permitted or accepted. For example, the processing unit 110 causes the communication unit 120 to transmit control information for displaying a display indicating permission or acceptance of the content generation to the device detection device 90 in the region 80. In the example shown in FIGS. 6A and 6B, the processing unit 110 causes a display unit 900a of the device detection device 90a to display a character string “OK”. Furthermore, in the example shown in FIG. 7, the processing unit 110 causes the device detection device 90b to emit the LED of a first color (blue or the like) among LEDs 900b of three colors. According to these examples, use of the user device 20 in the region 80 may be permitted or accepted, for example, by a person in charge in the region 80 or the like.

Furthermore, the processing for permitting or accepting the content generation may include causing the communication unit 120 to transmit to the user device 20 information indicating that the content generation is permitted or accepted. In this case, the processing unit 110 can permit or accept (directly) the content generation to the user device 20.

Note that, in a case where the content generation is permitted, for example, a processing circuit such as a CPU in the user device 20 can access a sensor unit 226 (such as an imaging unit or a sound collection unit) in the user device 20, or the processing circuit can acquire data sensed by the sensor unit 226 from the sensor unit 226. Furthermore, in a case where the content generation is permitted, for example, the processing circuit in the user device 20 is not inhibited from accessing the sensor unit 226 in the user device 20, or the processing circuit is not inhibited from acquiring data sensed by the sensor unit 226 from the sensor unit 226.

### Prohibition or Restriction of Content Generation

Next, the specific contents of the “processing for prohibiting or restricting content generation” will be described. For example, the processing for prohibiting or restricting the content generation may include causing the display unit to display a display indicating that the content generation is prohibited or restricted. For example, the processing unit 110 causes the communication unit 120 to transmit control information for displaying a display indicating prohibiting or restricting of the content generation to the device detection device 90 in the region 80. In the example shown in FIGS. 6A and 6B, the processing unit 110 causes a display unit 900a of the device detection device 90a to display a character string “NG”. Furthermore, in the example shown in FIG. 7, the processing unit 110 causes the device detection device 90b to emit the LED of a second color (red or the like) (different from the first color) among the LEDs 900b of three colors. According to these examples, use of the user device 20 in the region 80 may be prohibited or restricted, for example, by a person in charge in the region 80 or the like.

Furthermore, the processing for prohibiting or restricting the content generation may include causing the communication unit 120 to transmit information indicating that the content generation is prohibited or restricted to the user device 20. In this case, the processing unit 110 can prohibit or restrict (directly) the content generation to the user device 20.

Note that, in a case where the content generation is prohibited, for example, a processing circuit such as a CPU in the user device 20 cannot access a sensor unit 226 (such as an imaging unit or a sound collection unit) in the user device 20, or the processing circuit cannot acquire data sensed by the sensor unit 226 from the sensor unit 226. Furthermore, in a case where the content generation is restricted, for example, the processing circuit in the user device 20 is inhibited (restricted) from accessing the sensor unit 226 in the user device 20, or the processing circuit is inhibited (restricted) from acquiring data sensed by the sensor unit 226 from the sensor unit 226.

### Modification

Note that the processing unit 110 can also perform processing for permitting or accepting the content generation according to the type of each of the business license and the owner license possessed by the user device 20.

For example, a plurality of types of business licenses may be issued by the business operator in association with the context ID. In this case, the processing unit 110 may perform processing for permitting or accepting the content generation according to all the business licenses determined to be possessed by the user device 20 among the plurality of types of business licenses. Here, each of the plurality of types of business licenses may be business licenses having different acquisition conditions. For example, the plurality of types of business licenses include a basic license and an additional license. Here, the basic license is a business license that any user device 20 can acquire. Furthermore, the additional license may be, for example, a business license that can be acquired (for example, additionally) only by the user device 20 being used by the user 2 who has user authenticated, the business license issued (for example, additionally) only to the user device 20 being used by the user 2 who has purchased a predetermined ticket, or a business license issued (for example, additionally) only to the user device 20 being used by the user 2 who has achieved a predetermined condition under a context corresponding to the content ID. Note that the predetermined condition may be, for example, that the user 2 reaches the goal at a predetermined attraction in a predetermined theme park.

Furthermore, a plurality of types of owner licenses may be issued by the user 2 using the user device 20 in association with the context ID. In this case, the processing unit 110 may perform processing for permitting or accepting the content generation according to all the owner licenses determined to be possessed by the user device 20 among the plurality of types of owner licenses. Note that the specific example of the plurality of types of owner licenses may be similar to the specific example of the plurality of types of business licenses.

Note that in a case where the user device 20 has a plurality of types of business licenses, the function corresponding to the union of functions permitted by each of the plurality of business licenses (in other words, the OR condition) may be permitted to the user device 20 by the plurality of types of business licenses. Furthermore, in a case where the user device 20 has a plurality of types of owner licenses, the function corresponding to the union of functions permitted by each of the plurality of owner licenses (the OR condition) may be permitted to the user device 20 by the plurality of types of owner licenses. In other words, in a case where the user device 20 has a plurality of types of business licenses and a plurality of types of owner licenses, only the function corresponding to the product set (AND condition) of the union (OR condition) of functions permitted by each of the plurality of types of business licenses and the union (OR condition) of the functions permitted by each of the plurality of types of owner licenses is permitted to the user device 20.

### 2-1-1-7. Communication Unit 120

The communication unit 120 may include, for example, a communication device 162 as described later. The communication unit 120 transmits and receives information with other devices. For example, the communication unit 120 transmits information indicating permission or acceptance for the content generation to the user device 20 according to the control of the processing unit 110. Alternatively, the communication unit 120 transmits control information for displaying a display indicating permission or acceptance of the content generation to the verification device 90 according to the control of the processing unit 110. Furthermore, the communication unit 120 receives, from the device detection device 90, a result as to whether or not a valid response corresponding to the device determination request has been received from the user device 20.

### 2-1-1-8. Storage Unit 122

The storage unit 122 may include, for example, a storage device 160 as described later. The storage unit 122 stores various types of data and various types of software.

### 2-1-2. User Device 20

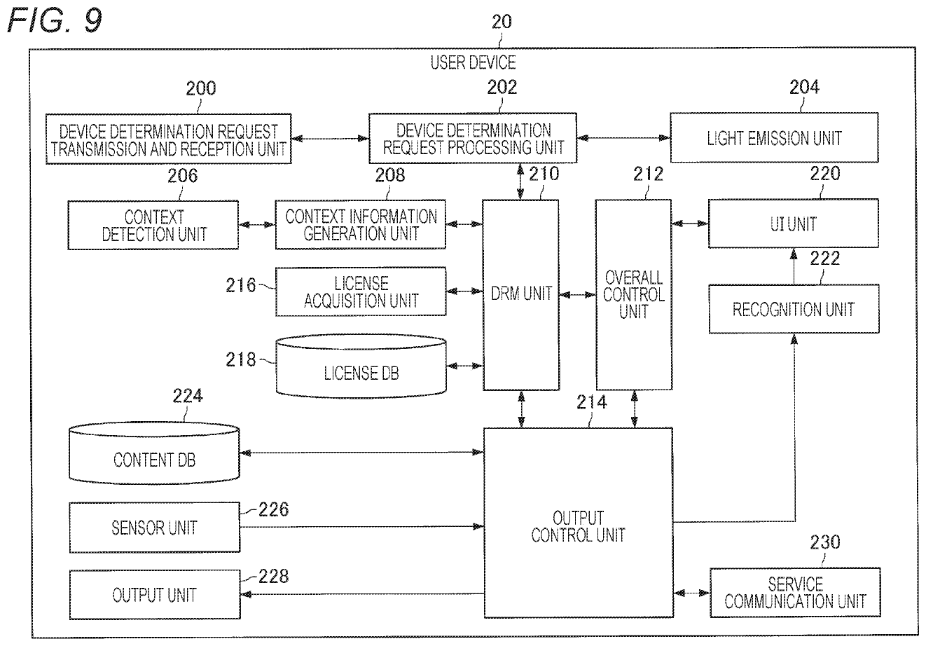

Next, the configuration of the user device 20 according to the present embodiment will be described. FIG. 9 is a functional block diagram showing a configuration example of the user device 20 according to the present embodiment. As shown in FIG. 9, for example, the user device 20 includes a device determination request transmission and reception unit 200, a device determination request processing unit 202, a light emission unit 204, a context detection unit 206, a context information generation unit 208, and a digital rights management (DRM) unit 210, an overall control unit 212, an output control unit 214, a license acquisition unit 216, a license DB 218, a UI unit 220, a recognition unit 222, a content DB 224, a sensor unit 226, an output unit 228, and a service communication unit 230.

### 2-1-2-1. Device Determination Request Transmission and Reception Unit 200

The device determination request transmission and reception unit 200 receives (or detects) a corresponding device determination request transmitted by the device detection device 90 (for example, in the region 80). Then, the device determination request transmission and reception unit 200 transmits the received corresponding device determination request to the device determination request processing unit 202 as described later.

Furthermore, the device determination request transmission and reception unit 200 transmits the response acquired from the device determination request processing unit 202 to the device detection device 90.

### 2-1-2-2. Device Determination Request Processing Unit 202

The device determination request processing unit 202 transmits, to the DRM unit 210, a corresponding device determination request acquired from the device determination request transmission and reception unit 200. Furthermore, the device determination request processing unit 202 transmits the response acquired from the DRM unit 210 to the device determination request transmission and reception unit 200 or the light emission unit 204. For example, in a case where the response is a response using light emission, the device determination request processing unit 202 transmits the response to the light emission unit 204. Furthermore, in a case where the response is a response that does not use light emission, the device determination request processing unit 202 transmits the response to the device determination request transmission and reception unit 200.

### 2-1-2-3. Light Emission Unit 204

The light emission unit 204 includes, for example, a visible light LED, an infrared LED, or the like. The light emission unit 204 emits light according to the response acquired from the device determination request processing unit 202.

### 2-1-2-4. Context Detection Unit 206

### Detection at Arbitrary Timing

The context detection unit 206 detects information regarding the context in which the user device 20 is currently located. For example, the context detection unit 206 detects a context ID at an arbitrary timing by the detection method below. Note that the context detection unit 206 may detect the context ID by using any two or more of the following “detection method A1” to “detection method A5” in combination, or may detect the context ID by using only one the detection methods.

### Detection Method A1

The contents of “detection method A1” to “detection method A5” will be described below. For example, the context detection unit 206 may include a receiver that receives positioning signals from positioning satellites such as the global positioning system (GPS) and the global navigation satellite system (GLONASS). For example, the context detection unit 206 first specifies position information (such as latitude and longitude) of the user device 20 on the basis of the positioning signal received from the positioning satellite. Then, the context detection unit 206 inquires a predetermined device (for example, the server 10 or the like) for a context ID corresponding to the specified position information to specify the context ID.

### Detection Method A2

Furthermore, a wireless LAN access point installed in the region 80 may transmit information including the context ID. In this case, the context detection unit 206 may detect the context ID on the basis of the reception from the access point.

### Detection Method A3

Furthermore, the speaker installed in the region 80 may output predetermined audio (for example, audio having a frequency exceeding the human audible range, or the like) on which the context ID is superimposed. In this case, the context detection unit 206 may detect the context ID on the basis of the detection result of the predetermined audio.

### Detection Method A4

Furthermore, the illumination installed in the region 80 may emit light in a predetermined blinking pattern (for example, a pattern of blinking intervals that human beings cannot perceive, or the like) on which the context ID is superimposed. In this case, for example, the context detection unit 206 may detects the predetermined blink pattern on the basis of a captured image by the sensor unit 226 (imaging unit) to detect the context ID.

### Detection Method A5

Furthermore, an image (digital watermark) in which the context ID is embedded may be displayed by the display unit installed in the region 80 or projected on a screen (such as a wall surface) in the region 80. In this case, for example, the context detection unit 206 may analyze a captured image of the image by the sensor unit 226 (imaging unit) to detect the context ID.

### Detection When User 2 Enters or Exits from Region 80

Alternatively, when the user 2 (having the corresponding user device 20) enters or exits from the region 80, the context detection unit 206 can detect the context ID by, for example, the “detection method B1” to “detection method B4” below. Note that the context detection unit 206 may detect the context ID by using any two or more of the following “detection method B1” to “detection method B4” in combination, or may detect the context ID by using only one the detection methods.

### Detection Method B1

For example, when the user 2 enters the region 80, a person in charge may hold a predetermined device having an NFC function over the user device 20 that the user 2 has. In this case, the context detection unit 206 can detect the context ID notified by NFC from the predetermined device.

### Detection Method B2

Furthermore, a predetermined device possessed by a person in charge in the region 80 may display a predetermined marker (such as a two-dimensional code) associated with the context ID, and the user 2 entering the region 80 may hold the user device 20 over the predetermined device. In this case, the context detection unit 206 can read a predetermined marker displayed on the predetermined device to detect the context ID.

### Detection Method B3

Furthermore, for example, when the user 2 enters or exits from the region 80, the user 2 holds the user device 20 over the predetermined device having an NFC function possessed by a person in charge, and the predetermined device may acquire the device ID of the user device 20 by NFC. In this case, the context detection unit 206 detects the context ID notified from the predetermined device, for example, by another communication unit (such as a wireless LAN) on the basis of the device ID.

### Detection Method B4

Furthermore, for example, when the user 2 enters or exits from the region 80, the user device 20 may display a predetermined marker (such as a two-dimensional code) associated with the device ID of the user device 20, and a person in charge may read the predetermined marker by a predetermined device. In this case, the context detection unit 206 detects the context ID notified from the predetermined device, for example, by another communication means (such as wireless communication) on the basis of the device ID associated with the predetermined marker.

Note that in a case where the context ID is detected, the context detection unit 206 may consider that the user device 20 is continuously located for a predetermined period under the context corresponding to the context ID (that is, the context ID does not change). For example, in a case where the context ID is detected when the user 2 enters the region 80, the context detection unit 206 may consider that the user device 20 is continuously located for a predetermined period under the context corresponding to the context ID. As a result, for example, even in a case where the user 2 temporarily exits from the region 80, the user device 20 does not have to detect the context ID again. Furthermore, in a case where the user 2 exits from the region 80 without performing a predetermined procedure, it is possible to prevent the context ID corresponding to the region 80 from becoming valid unlimitedly, for example.

### 2-1-2-5. Context Information Generation Unit 208

The context information generation unit 208 generates the context ID on the basis of the information acquired from the context detection unit 206. For example, in a case where the context ID is detected by the context detection unit 206, the context information generation unit 208 uses the detected context ID as it is as a generation target context ID. Furthermore, in a case where the context detection unit 206 detects location information or date and time information, the context information generation unit 208 generates the context ID corresponding to the detected location information or date and time information.

### 2-1-2-6. DRM Unit 210

### Processing Example 1

The DRM unit 210 generates a unique content ID (assigned to the content to be generated) on the basis of a request from the output control unit 214 as described later. Then, the DRM unit 210 transmits the generated content ID to the output control unit 214.

### Processing Example 2

Furthermore, the DRM unit 210 generates an acquisition request for the business license and the owner license on the basis of the context ID acquired from the context information generation unit 208, the generated content ID, or the like. Then, the DRM unit 210 causes the license acquisition unit 216 as described later to transmit the acquisition request to the license server 30. Furthermore, in a case where the business license and the owner license are received from the license server 30, the DRM unit 210 stores these licenses in a license DB 218 as described later.

### Processing Example 3

Furthermore, the DRM unit 210 generates a content key on the basis of the context ID, the content ID, the business license, and the owner license. For example, the DRM unit 210 generates a content key using a predetermined function described below.

Content key=f (context ID, device ID, content ID, owner ID, first key generation information, second key generation information)

Note that, as described above, the first key generation information is key generation information included in the business license, and the second key generation information is key generation information included in the owner license.

Then, the DRM unit 210 transmits the generated content key to the output control unit 214. Note that the transfer of information between the DRM unit 210 and the output control unit 214 may be protected by, for example, a local encryption.

### Processing Example 4

Furthermore, the DRM unit 210 decrypts the (encrypted) device determination request acquired from the device determination request processing unit 202 on the basis of, for example, a built-in predetermined key and a context ID. Then, the DRM unit 210 generates a response corresponding to the device determination request according to the result of the decryption. Note that the DRM unit 210 may further encrypt the response on the basis of a predetermined key.

### 2-1-2-7. Overall Control Unit 212

The overall control unit 212 controls the entire user device 20.

### 2-1-2-8. Output Control Unit 214

### Generation of Content

The output control unit 214 generates content (stream) on the basis of data sensed by the sensor unit 226 as described later, a content ID acquired from the DRM unit 210, or the like. For example, the output control unit 214 generates content by embedding license acquisition information in content to be generated according to sensed data.

### Encryption Processing

Furthermore, the output control unit 214 encrypts the generated content on the basis of the content key acquired from the DRM unit 210. Note that, in a case where the output destination of the content is the inside of the user device 20 (for example, the recognition unit 222, the content DB 224, the output unit 228, or the like), and it is guaranteed that the related part (hardware or software) of the user device 20 is securely implemented, the output control unit 214 may not encrypt the corresponding content.

### Output Control

Furthermore, the output control unit 214 performs output control of the encrypted content on the basis of the business license and the owner license acquired from the DRM unit 210. For example, the output control unit 214 transmits the content only to an output destination corresponding to the function permitted by both the business license and the owner license (more specifically, the recognition unit 222, the content DB 224, the output unit 228, or the service communication unit 230).

Note that, in the above description, an example in which the output control unit 214 performs all of content generation processing, encryption processing, and output control has been described, but the present invention is not limited to this example. For example, a stream generation unit and/or an encryption processing unit may be provided in the user device 20. In this case, the stream generation unit may perform content generation processing (instead of the output control unit 214), and the encryption processing unit may perform encryption processing (instead of the output control unit 214).

### 2-1-2-9. License Acquisition Unit 216

The license acquisition unit 216 transmits the acquisition request for the business license and the owner license to the license server 30 according to the control of the DRM unit 210.

### 2-1-2-10. License DB 218

The license DB 218 securely stores the business license and the owner license acquired from the license server 30.

### 2-1-2-11. UI Unit 220

The UI unit 220 performs processing related to the UI of the system. For example, the UI unit 220 performs display control of the UI on an output unit 228 (display unit) as described later.

### 2-1-2-12. Recognition Unit 222

The recognition unit 222 performs recognition processing on the content acquired from the output control unit 214. Furthermore, the recognition unit 222 transmits the recognition result to, for example, the UI unit 220.

### 2-1-2-13. Content DB 224

The content DB 224 stores the content acquired from the output control unit 214.

### 2-1-2-14. Sensor Unit 226

The sensor unit 226 includes, for example, an imaging unit (such as a camera) and a sound collection unit (such as a microphone). The imaging unit captures, for example, 2D video and 3D video. For example, the user device 20 may have a plurality of imaging units and may be able to capture an omnidirectional video.

Furthermore, the sensor unit 226 may further include other various sensors (for example, an odor sensor, a thermometer, a pressure sensor, a depth sensor, and the like).

### 2-1-2-15. Output Unit 228

The output unit 228 displays a video or outputs an audio according to the control of the output control unit 214. The output unit 228 includes, for example, a display unit and an audio output unit. The display unit may include, for example, a display such as a liquid crystal display (LCD) or an organic light emitting diode (OLED), or may include a projector. Furthermore, the audio output unit may include a speaker.

### 2-1-2-16. Service Communication Unit 230

The service communication unit 230 transmits various processing requests to the various functions server 32 according to the control of the output control unit 214. For example, the service communication unit 230 transmits the content to the various functions server 32 according to the control of the output control unit 214. As a result, recognition of the content, storage of the content, space sharing with another user device 20, distribution of the content to another user device 20, sharing of the content with another user device 20, or the like may be executed by the various functions server 32.

Note that the configuration of the user device 20 is not limited to the example described above. For example, the DRM unit 210 and the output control unit 214 may be integrally configured.

### 2-2. Flow of Processing

The configuration according to the present embodiment has been described above. Next, the flow of processing according to the present embodiment will be described. Specifically, description will be made in the order of “2-1-2. Flow of Processing in Determination of Validity of User Device 20”, “2-2-2. Flow of Processing for Generating Content”, and “2-2-3. Flow of Processing In Using Content”.

### 2-2-1. Flow of Processing in Determination of Validity of User Device 20

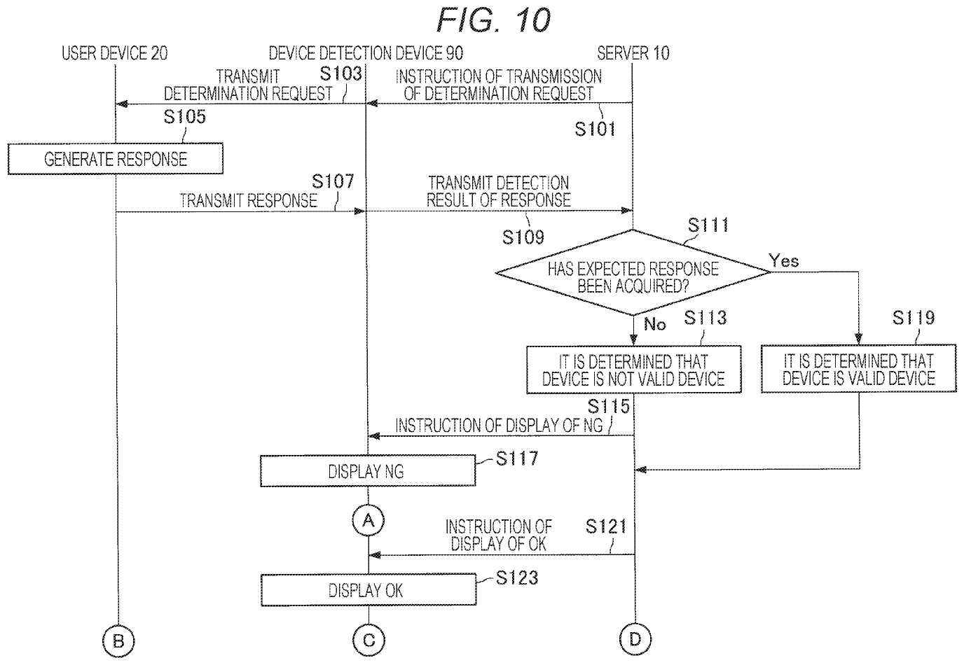

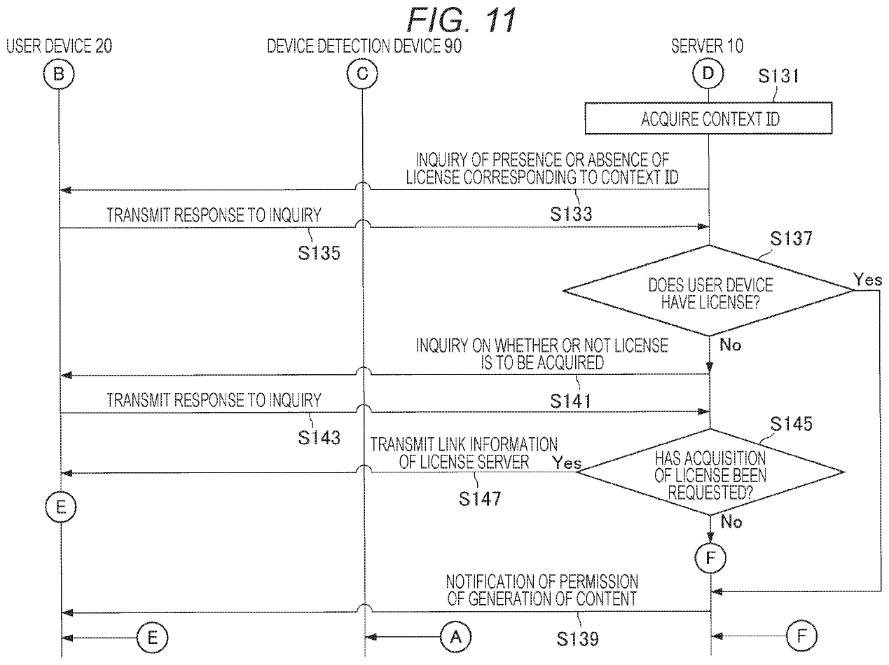

First, with reference to FIGS. 10 and 11, the “Flow of Processing in Determination of Validity of User Device 20” will be described. FIGS. 10 and 11 are sequence diagrams showing the “Flow of Processing in Determination of Validity of User Device 20”. Note that, in the following, an example of the flow of processing when the user 2 having the user device 20 enters the region 80 will be described. Furthermore, an example in which the device detection device 90 is installed near the entrance of the region 80 will be described.

As shown in FIG. 10, first, the communication unit 120 of the server 10 transmits the device determination request transmission instruction (including, for example, a light emission pattern instruction, or the like) to the device detection device 90 according to the control of the device determination unit 104. (S101).

Thereafter, the device detection device 90 transmits a signal (for example, radio wave, light, audio, or the like) of the device determination request to the user device 20 on the basis of the received transmission instruction (S103).

Thereafter, the user device 20 generates a response on the basis of the signal received in S103 (S105). Then, the user device 20 transmits the generated response signal (for example, radio wave, light, audio, or the like) to the device detection device 90 (S107).

Thereafter, the device detection device 90 detects the signal transmitted in S107, and transmits the detection result to the server 10 (S109).

Thereafter, the device determination unit 104 of the server 10 determines whether or not a valid response corresponding to the device determination request transmitted in S103 has been detected by the device detection device 90 (S111). In a case where it is determined that a valid response has not been detected (S111: No), first, the device determination unit 104 determines that the corresponding user device 20 is not a valid device (S113). Subsequently, under the control of the processing unit 110, the communication unit 120 transmits control information for displaying a display indicating “NG” to the device detection device 90 (S115). Thereafter, the device detection device 90 displays a display indicating “NG” according to the received control information (S117). As a result, for example, a person in charge in the region 80 causes the user device 20 not to be used in the region 80. Then, the flow of the processing ends.

On the other hand, in a case where it is determined that a valid response has been detected (S111: Yes), first, the device determination unit 104 determines that the corresponding user device 20 is a valid device (S119). Then, under the control of the processing unit 110, the communication unit 120 transmits control information for displaying a display indicating “OK” to the device detection device 90 (S121).

Thereafter, the device detection device 90 displays a display indicating “OK” according to the received control information (S123).

Here, referring to FIG. 11, a flow of processing after S123 will be described. As shown in FIG. 11, after S121, the information acquisition unit 102 of the server 10 acquires a context ID. For example, the information acquisition unit 102 may acquire the context ID corresponding to the location of the region 80 and the current date and time information, or may inquiry to the user device 20 to acquire the context ID detected by the user device 20 from the user device 20 (S131).

Subsequently, under the control of the license determination unit 106, the communication unit 120 transmits, to the user device 20, an inquiry about the presence or absence of the business license and the owner license corresponding to the acquired context ID (S133).

Thereafter, the user device 20 transmits a response corresponding to the received inquiry (that is, a response as to whether or not the user device 20 has the business license and the owner license) to the server 10 (S135).

Thereafter, the license determination unit 106 determines whether or not the user device 20 has the business license and the owner license on the basis of the received response (S137). In a case where it is determined that the user device 20 has the business license and the owner license (S137: Yes), the processing unit 110 causes the communication unit 120 to transmit information indicating that the content generation by the user device 20 is permitted or accepted the content generation to the user device 20 (S139). Then, the processing ends.

On the other hand, in a case where it is determined that the user device 20 does not have at least one of the business license or the owner license (S137: No), first, the inquiry unit 108 causes the communication unit 120 to transmit the inquiry as to whether or not the user device 20 acquires the license (business license and/or owner license) that the user device 20 does not have (S141).

Thereafter, the user device 20 transmits an answer corresponding to the received inquiry to the server 10 (S143).

Thereafter, the processing unit 110 of the server 10 determines whether or not the received response indicates that the acquisition of the corresponding license is desired (S145). In a case where the response indicates that the acquisition of the corresponding license is not desired (S145: No), the processing ends.

On the other hand, in a case where the response indicates that the acquisition of the corresponding license is desired (S145: Yes), the communication unit 120 transmits the link information of the license server 30 to the user device 20 according to the control of the processing unit 110 (S147). Then, the processing ends.

### 2-2-1-1. Modification

Note that the “Flow of Processing in Determination of Validity of User Device 20” is not limited to the above-described example. For example, as a modification of S101 to S103, the device detection device 90 may transmit a signal of the device determination request (autonomously) to the user device 20. Furthermore, as a modification of S109 to S111, instead of the server 10, the device detection device 90 may determine whether or not the response signal received in S107 is a valid response corresponding to the device determination request transmitted in S103.

### 2-2-2. Flow of Content Generation Processing

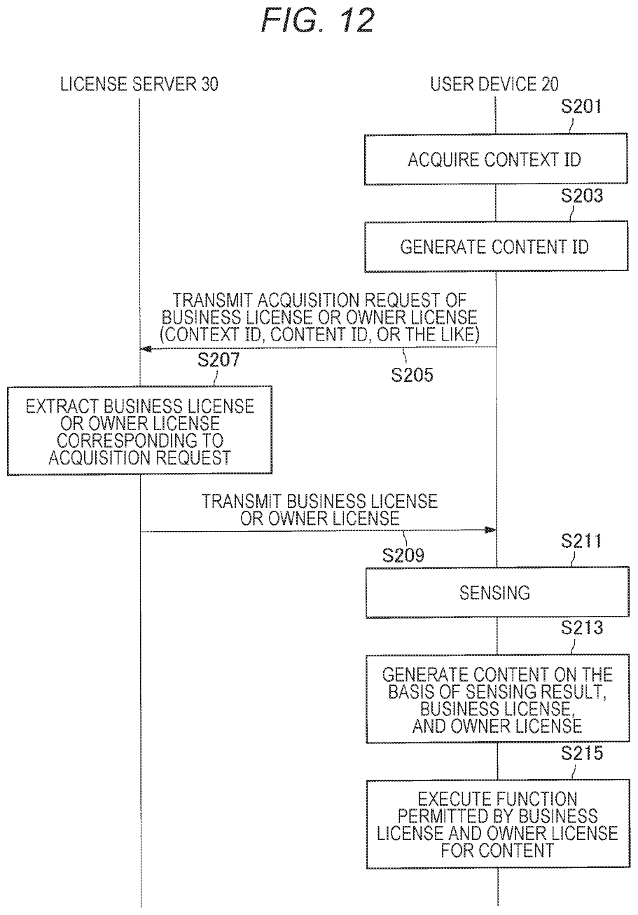

Next, the “a flow of content generation processing” will be described with reference to FIG. 12. FIG. 12 is a sequence diagram showing “a flow of content generation processing”. Note that, for example, in a case where it is determined that the user device 20 is a valid device according to the flow of the processing shown in FIGS. 10 and 11, the processing may be performed.

As shown in FIG. 12, first, the user device 20 detects a context ID corresponding to the environment in which the user is currently located (S201).

Subsequently, the user device 20 generates a content ID to be assigned to the content to be generated (S203).

Subsequently, the user device 20 transmits, to the license server 30, an acquisition request for a license that the user device 20 does not have among the business license and the owner license. Here, the acquisition request for the license includes the context ID detected in S201, the content ID generated in S203, or the like (S205).

Thereafter, the license server 30 extracts the business license and/or the owner license corresponding to the acquisition request of the license from the predetermined database (S207). Then, the license server 30 transmits the extracted business license and/or owner license to the user device 20. Thereafter, the user device 20 stores the received business license and/or owner license (S209).

Thereafter, the user device 20 performs sensing (for example, imaging, or the like) in the current environment (S211).

Subsequently, the user device 20 generates content on the basis of the sensing result in S211 and the stored business license and owner license. For example, the user device 20 encrypts the sensing result in S211 on the basis of the business license and the owner license to generate content (S213).

Thereafter, the user device 20 executes one of the functions permitted by the business license and the owner license on the content generated in S213 on the basis of, for example, the user's operation, or the like (S215).

### 2-2-2-1. Modification

Note that the “flow of content generation processing” is not limited to the example described above. For example, in a case where the user device 20 already has both the business license and the owner license corresponding to the context ID detected in S201, the processing of S205 to S209 may be omitted.

### 2-2-3. Flow of Processing in Using Content

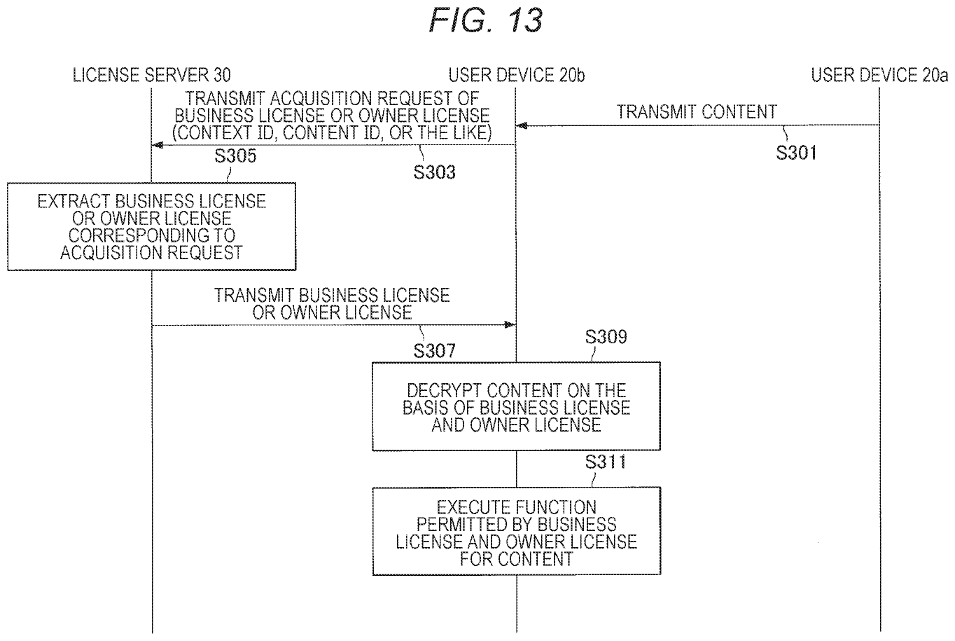

Next, the “a flow of processing in using content” will be described with reference to FIG. 13. FIG. 13 is a sequence diagram showing “a flow of processing in using content”. Note that, the processing may be performed after the content is generated by a certain user device 20a, for example, according to the flow of the processing shown in FIG. 12. Furthermore, in the following, an example in which the distribution of content is permitted to the user device 20a will be described.

As shown in FIG. 13, first, the user device 20a transmits the generated content to the user device 20b located at a remote location, for example, via the communication network 34 (S301).

Thereafter, the user device 20b transmits an acquisition request for the business license and the owner license to the license server 30. Here, the acquisition request for the license includes a context ID, a content ID, and the like corresponding to the corresponding content (S303).

Thereafter, the license server 30 extracts the business license and the owner license corresponding to the acquisition request of the license from the predetermined database (S305). Then, the license server 30 transmits the extracted business license and owner license to the user device 20b. Thereafter, the user device 20b stores the received business license and owner license (S307).

Thereafter, the user device 20b decrypts the content received in S301 on the basis of the received business license and owner license (S309).

Thereafter, the user device 20b executes any of types of the functions permitted by the business license and the owner license on the content on the basis of, for example, the user's operation, or the like (S311).

### 2-3. Effect

### 2-3-1. Effect 1

As described above, according to the present embodiment, the server 10 acquires context information of a user device 20, determines whether or not the user device 20 has the business license according to the context information, and performs processing for permitting or allowing the user device 20 to generate the content in a case where it is determined that the user device 20 has the business license. For this reason, content generation by the user device 20 can be adaptively permitted or allowed depending on the context. For example, the content generation by the user device 20 can be permitted or accepted as the content pre-designated by the business operator in association with the context (location and date and time) indicated by the context information.

### 2-3-2. Effect 2

Furthermore, according to the present embodiment, for each context, the content generated by the user device 20 under the context can be protected. That is, with respect to data (content) sensed in real time by the user device 20 (rather than already recorded content), the operator can set in detail the type of function permitted (or restricted) to any device.

### 2-3-3. Effect 3

Furthermore, for example, in a case where the user 2 having the user device 20 enters the region 80, or the like, it is determined that the user device 20 is a valid device, and only in a case where it is determined that the user device 20 has the business license and the owner license corresponding to the context, the server 10 can permit the user device 20 to execute the functions permitted by the business license and the owner license. Therefore, for example, generation and utilization of the content by the user device 20 in the region 80 can be permitted and restricted according to the designation by the operator without uniformly prohibiting by the operator bringing of the user device 20 to the region 80. Accordingly, the profit of both the business operator and the user 2 can be maximized.

Furthermore, according to the present embodiment, only functions permitted by both the business license and the owner license may be permitted to the user device 20. Therefore, execution of the function can be permitted or restricted to the user device 20 reflecting the intentions of both the business operator (that is, the provider of the experience in the region 80) and the creator of the content (that is, the user 2).

Furthermore, with respect to the content generated by the user device 20, the operator can specify in detail whether or not execution by any device is permitted for each function. For example, unlike known techniques, the operator can specify whether or not to permit functions other than reproduction.

### 2-3-4. Effect 4

Furthermore, according to the present embodiment, the business operator can distribute the business license to the user device 20 by various distribution methods. For example, the business operator can distribute the business license locally, can distribute the business license via the communication network 34 after performing user authentication, or can distribute only to the special user device 20 (for example, the user device 20 of the user 2 who has purchased the predetermined ticket, or the like). Accordingly, appropriate license management and usage can be realized depending on the application.

### 2-4. Application Example

Next, application examples according to the present embodiment will be described in “2-4-1. Application Example 1” to “2-4-4. Application Example 4”.

### 2-4-1. Application Example 1

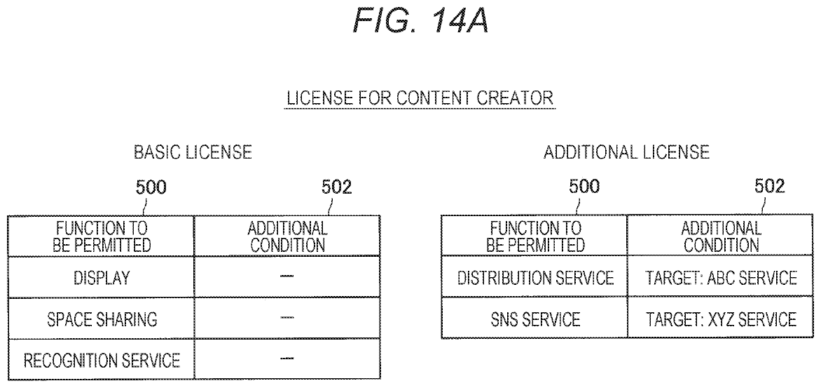

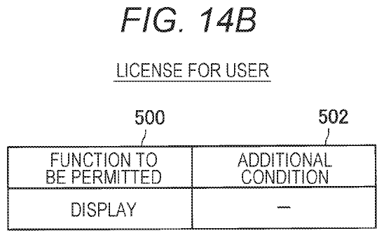

First, Application Example 1 will be described. In the application example 1, it is assumed that the region 80 is a theme park 80a (such as an amusement park), and that the business operator is an operator of the theme park 80a. In this case, for example, as shown in FIG. 14A, for each user device 20 located in the theme park 80a, only “display”, “space sharing” and “use of recognition service” are permitted (by the basic business license). Furthermore, in a case where the user 2 of the user device 20 purchases a predetermined ticket, or in a case where the user 2 is a special member, an additional business license is given to the user device 20, so that “use of distribution service” and “use of SNS service” are further permitted. As a result, the purchaser of the predetermined ticket or the special member are permitted to distribute the video shot in the theme park 80a to the other user 2 or to share the video with the other user 2.

Furthermore, as shown in FIG. 14B, only “display” is permitted for each user device 20 located outside the theme park 80a with respect to the content generated in the theme park 80a.

### 2-4-2. Application Example 2

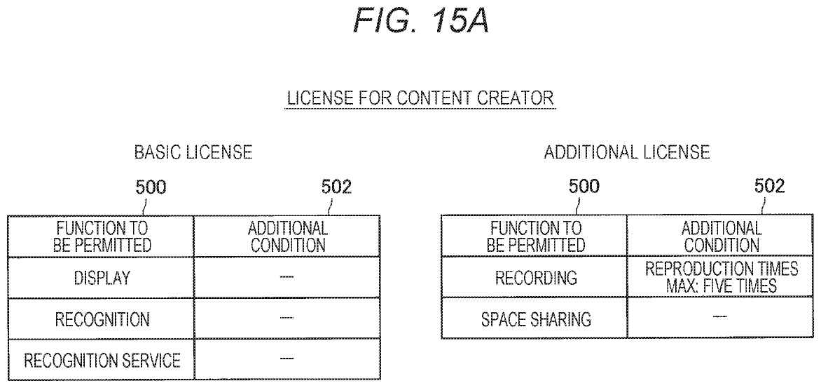

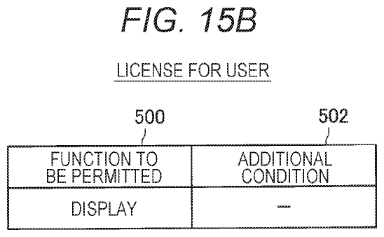

Next, Application Example 2 will be described. In Application Example 2, it is assumed that the region 80 is a movie theater 80b and that the business operator is an operator of the movie theater 80b. In this case, for example, as shown in FIG. 15A, for each user device 20 located in the movie theater 80b, only “display”, “recognition” and “use of recognition service” are permitted (by the basic business license). Furthermore, in a case where the user 2 of the user device 20 purchases a predetermined ticket, or in a case where the user 2 is a special member, an additional business license is given to the user device 20, so that “recording of content (to the user device 20)” and “space sharing” are further permitted. As a result, the purchaser of the predetermined ticket or the special member are permitted to save the video of the movie taken in the movie theater 80b only on his/her device, and share the space (that is, to cause a user of the remote location to view the video of the movie).

Furthermore, as shown in FIG. 15B, only “display” is permitted for each user device 20 located outside the movie theater 80b with respect to the content generated in the movie theater 80b.

### 2-4-3. Application Example 3

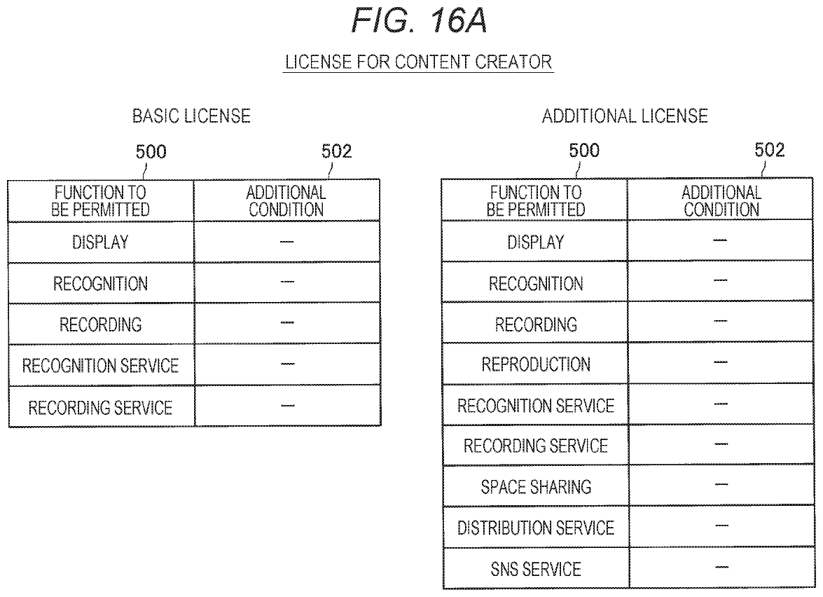

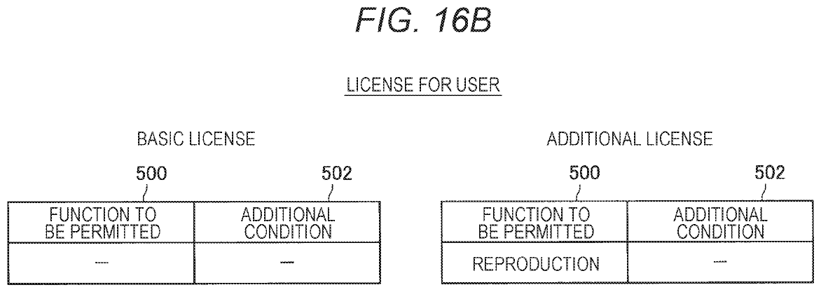

Next, Application Example 3 will be described. In the application example 3, it is assumed that the region 80 is a site 80c of an athletic meet, and the corresponding date and time is a day of the athletic meet. Furthermore, the business operator may be a school operator (such as a principal). In this case, for example, as shown in FIG. 16A, only “display”, “recognition”, and “recording” are permitted (by the basic business license) to each user device 20 during the athletic meet time zone (that is, “reproduction” is not allowed). Furthermore, in a case where the user 2 of the user device 20 is authenticated as a family of a student (of the school) by user authentication, an additional business license is given to the user device 20, so that all functions including “reproduction” are permitted. As a result, the visitors other than the student's family are permitted to shoot, but are not permitted to reproduce the shot content. Furthermore, all functions are permitted for the student's family.

Furthermore, as shown in FIG. 16B, with respect to each user device 20 located outside the site 80c of the athletic meet, in a case where the user 2 of the user device 20 is not authenticated as a student's family by user authentication, all functions are not permitted. Furthermore, in a case where the user 2 of the user device 20 is authenticated as a student's family by user authentication, an additional business license is given to the user device 20, so that only “reproduction” is permitted for the content generated in the site 80c.

### 2-4-4. Application Example 4

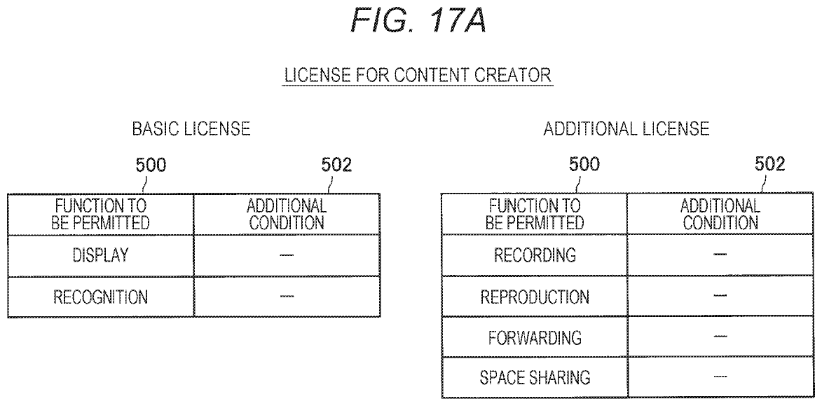

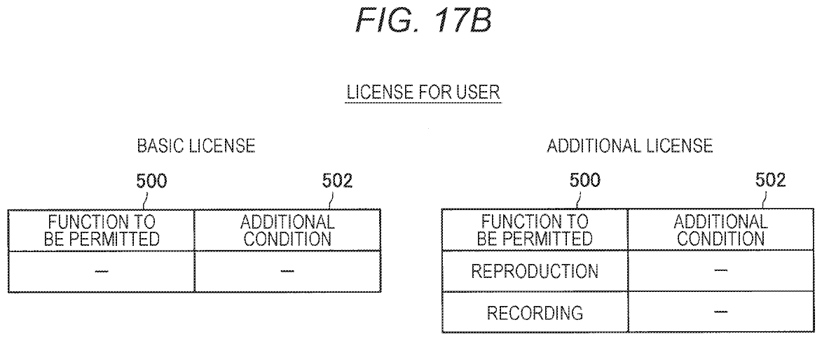

Next, Application Example 4 will be described. In Application Example 4, the region 80 may be an office 80d of a company, and the business operator may be a manager of the company. In this case, for example, as shown in FIG. 17A, only “display” and “recognition” are permitted (by the basic business license) to each user device 20 located in the office 80d. Furthermore, in a case where the user 2 of the user device 20 is authenticated as an employee of the company by user authentication, an additional business license is given to the user device 20, so that “recording”, “reproduction”, “forwarding”, and “space sharing” are further permitted. Note that, for security protection, use of external services is not permitted at all.

Furthermore, as shown in FIG. 17B, with respect to each user device 20 located outside the office 80d, in a case where the user 2 of the user device 20 is not authenticated as an employee by user authentication, all functions are not permitted. Furthermore, in a case where the user 2 of the user device 20 is authenticated as an employee by user authentication, an additional business license is given to the user device 20, so that only “reproduction” and “recording” are permitted for the content generated in the office 80d.

### 3. Hardware Configuration

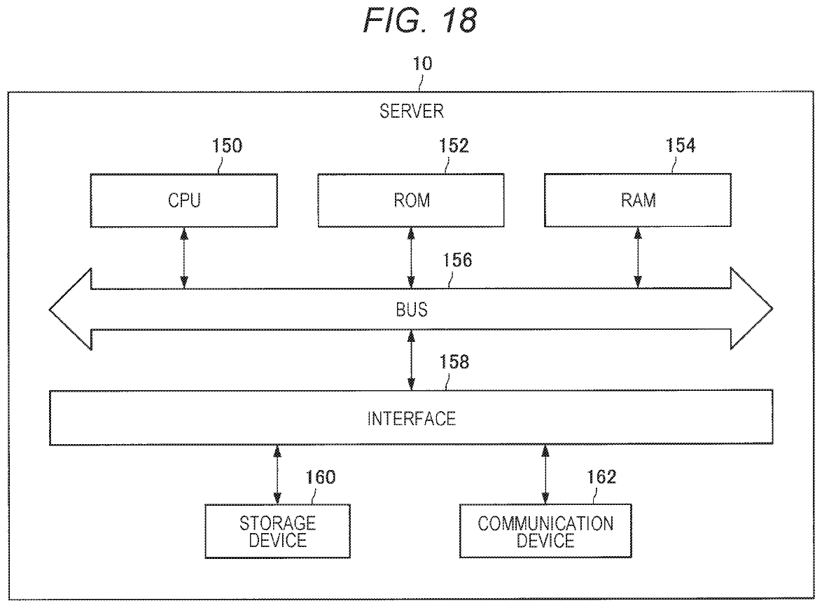

Next, the hardware configuration of the server 10 according to the present embodiment will be described with reference to FIG. 18. As shown in FIG. 18, the server 10 includes a CPU 150, a read only memory (ROM) 152, a random access memory (RAM) 154, a bus 156, an interface 158, a storage device 160, and a communication device 162.

The CPU 150 functions as an operation processing device and a control device, and controls the overall operation in the server 10 according to various programs. Note that the CPU 150 includes a processor such as a microprocessor. The CPU 150 may function as the control unit 100 in the server 10.

The ROM 152 stores control data such as program or operation parameters used by the CPU 150, or the like.

The RAM 154 temporarily stores, for example, programs executed by the CPU 150, or the like.

The bus 156 includes a CPU bus or the like. The bus 156 mutually connects the CPU 150, the ROM 152, and the RAM 154.

The interface 158 connects the storage device 160 and the communication device 162 to the bus 156.

The storage device 160 is a device for storing data. The storage device 160 includes, for example, a storage medium, a recording device that records data in the storage medium, a reading device that reads data from the storage medium, a deletion device that deletes data recorded in the storage medium, or the like. The storage device 160 may function as the storage unit 122 in the server 10.

The communication device 162 is a communication interface including a communication device, or the like for connecting to the communication network 34 or the like, for example. Furthermore, the communication device 162 may be a wireless LAN compatible communication device, a long term evolution (LTE) compatible communication device, or a wire communication device that performs wired communication. The communication device 162 may function as the communication unit 120 in the server 10.

### 4. Modification

While preferred embodiment of the present disclosure has been described in detail with reference to the accompanying drawings, the disclosure is not limited to such examples. It is obvious that various variations and modifications can be conceived within the scope of the technical idea described in the claims by a person having ordinary knowledge in the field of technology to which the present disclosure belongs, and, of course, it is understood that these variations and modifications belong to the technical scope of present disclosure.

For example, the configuration of the information processing system according to the embodiment described above is not limited to the example shown in FIG. 1. For example, any two or more of the server 10, the license server 30, and the various functions server 32 may be configured as an integrated device.

Furthermore, in the embodiment described above, an example in which the information processing apparatus according to the present disclosure is the server 10 has been described, but the present invention is not limited to such an example. For example, the information processing apparatus may be a general-purpose personal computer (PC), a tablet terminal, a game machine, a mobile phone such as a smartphone, a portable music player, a robot, or a wearable device such as an HMD or an AR glass, or the like.

Furthermore, as another modification, all the constituent elements included in the control unit 100 of the server 10 may be included in the device detection device 90 (instead of the server 10). In this case, the information processing device in the present disclosure may be the device detection device 90. Furthermore, in this case, the server 10 may not necessarily be installed.

Furthermore, each step in the flow of processing of the embodiment described above may not necessarily be processed in the described order. For example, each step may be processed in a changed order as appropriate. Furthermore, instead of being processed in chronological order, each step may be processed partly in parallel or separately. Furthermore, some of the steps described may be omitted, or additional steps may be further added.

Furthermore, according to the embodiment described above, it is also possible to provide a computer program for causing hardware such as the CPU 150, the ROM 152, the RAM 154, and the like to exhibit the same functions as those of each configuration of the server 10 according to the embodiment described above. Furthermore, a recording medium on which the computer program is recorded is also provided.

Furthermore, the effects described in this specification are merely illustrative or exemplary, and are not limitative. That is, the technique according to the present disclosure can exhibit other effects obvious to those skilled in the art from the description of the present specification together with the effects described above or instead of the effects described above.

Note that the following configuration is also within the technical scope of the present disclosure.

(1)

An information processing apparatus including:

an acquisition unit that acquires context information of a device;

a first determination unit that determines whether or not the device has a license for content generation according to the context information; and

a processing unit that performs processing for permitting or accepting the content generation by the device in a case where it is determined that the device has the license.

(2)

The information processing apparatus according to (1) described above, in which the context information includes location information or date and time information.

(3)

The information processing apparatus according to (1) or (2) described above, in which, in a case where it is determined that the device does not have the license, the processing unit performs processing for prohibiting or restricting the content generation by the device.

(4)

The information processing apparatus according to any one of (1) to (3) described above, further including

an inquiry unit that issues, to the device, an inquiry as to whether or not the license is acquired in a case where it is determined that the device does not have the license,

in which the processing unit further causes a communication unit to transmit, to the device, link information to a management device that stores the license on the basis of a response to the inquiry.

(5)

The information processing apparatus according any one of (1) to (4) described above, in which functions permitted to the device by the license include the content generation, reproduction of the content, and at least one function different from any of the generation and the reproduction of the content.

(6)

The information processing apparatus according to any one of (1) to (5) described above, in which the processing unit performs processing for permitting or accepting the content generation according to a type of the license that the device has.

(7)

The information processing apparatus according to (6) described above,

in which the license is issued by a first user different from a user of the device,

the first determination unit further determines whether or not the device has a sublicense issued by the user of the device, and

in a case where it is determined that the device has the license and the sublicense, the processing unit performs processing for permitting or accepting the content generation according to the license and the sublicense.

(8)

The information processing apparatus according to (6) or (7) described above,

in which a plurality of types of licenses for the content generation according to the context information are issued, and

the processing unit performs processing for permitting or accepting the content generation according to all the licenses determined to be possessed by the device among the plurality of types of licenses.

(9)

The information processing apparatus according to any one of (1) to (8) described above, in which the processing for permitting or accepting the content generation includes causing a display unit to display a display indicating that the content generation is permitted or accepted.

(10)

The information processing apparatus according to any one of (1) to (9) described above, in which the processing for permitting or accepting the content generation includes causing a communication unit to transmit, to the device, information indicating that the content generation is permitted or accepted.

(11)

The information processing apparatus according to any one of (1) to (10) described above, in which the context information is notified to the device at a location corresponding to the context information.

(12)

The information processing apparatus according to (11), in which the context information is notified to the device in a case where a user carrying the device enters or exits from a location corresponding to the context information.

(13)

The information processing apparatus according to any one of (1) to (12) described above, further including

a second determination unit that determines whether or not the device is a valid device on the basis of a detection result of a signal transmitted by the device,

in which, in a case where it is determined by the second determination unit that the device is not a valid device, the processing unit performs processing for prohibiting or restricting the content generation by the device.

(14)

The information processing apparatus according to (5) described above,

in which the device includes a sensor unit, and

the content is generated by the device on the basis of a sensing result by the sensor unit and the license.

(15)

The information processing apparatus according to (14) described above,

in which a sublicense is issued by a user of the device, and

the content is further generated by the device on the basis of the sublicense.

(16)

The information processing apparatus according to (15) described above, in which the content is generated by encrypting, by the device, the sensing result by the sensor unit on the basis of the license and the sublicense.

(17)

The information processing apparatus according to (15) or (16) described above, in which a type of function permitted to the device related to the content generated by the device is determined on the basis of the license and the sublicense.

(18)

The information processing apparatus according to (17) described above,

in which the content generated by the device is transmitted by the device to a second device,

in a case where the second device has the license and the sublicense, execution of a function according to the license and the sublicense regarding the content is permitted to the second device, and

in a case where the second device does not have the license or the sublicense, execution of a function related to the content is not permitted to the second device.

(19)

An information processing method including:

acquiring context information of a device;

determining whether or not the device has a license for content generation according to the context information; and

performing, by a processor, processing for permitting or accepting the content generation by the device in a case where it is determined that the device has the license.

(20)

A program for causing a computer to function as:

an acquisition unit that acquires context information of a device;

a first determination unit that determines whether or not the device has a license for content generation according to the context information; and

a processing unit that performs processing for permitting or accepting the content generation by the device in a case where it is determined that the device has the license.

### REFERENCE SIGNS LIST

10 Server
20 User device
30 License server
32 Various functions server
34 Communication network
90 Device detection device
100 Control unit
102 Information acquisition unit
104 Device determination unit
106 License determination unit
108 Inquiry unit
110 Processing unit
120 Communication unit
122 Storage unit
200 Device determination request transmission and reception unit
202 Device determination request processing unit
204 Light emission unit
206 Context detection unit
208 Context information generation unit
210 DRM unit
212 Overall control unit
214 Output control unit
216 License acquisition unit
218 License DB
220 UI unit
222 Recognition unit
224 Content DB
226 Sensor unit
228 Output unit
230 Service communication unit
900 Display unit

1. An information processing apparatus comprising:
an acquisition unit that acquires context information of a device;
a first determination unit that determines whether or not the device has a license for content generation according to the context information; and
a processing unit that performs processing for permitting or accepting the content generation by the device in a case where it is determined that the device has the license.

2. The information processing apparatus according to claim 1, wherein the context information includes location information or date and time information.

3. The information processing apparatus according to claim 1, wherein, in a case where it is determined that the device does not have the license, the processing unit performs processing for prohibiting or restricting the content generation by the device.

4. The information processing apparatus according to claim 1, further comprising
an inquiry unit that issues, to the device, an inquiry as to whether or not the license is acquired in a case where it is determined that the device does not have the license,
wherein the processing unit further causes a communication unit to transmit, to the device, link information to a management device that stores the license on a basis of a response to the inquiry.

5. The information processing apparatus according to claim 1, wherein functions permitted to the device by the license include the content generation, reproduction of the content, and at least one function different from any of the generation and the reproduction of the content.

6. The information processing apparatus according to claim 1, wherein the processing unit performs processing for permitting or accepting the content generation according to a type of the license that the device has.

7. The information processing apparatus according to claim 6,
wherein the license is issued by a first user different from a user of the device,
the first determination unit further determines whether or not the device has a sublicense issued by the user of the device, and
in a case where it is determined that the device has the license and the sublicense, the processing unit performs processing for permitting or accepting the content generation according to the license and the sublicense.

8. The information processing apparatus according to claim 6,
wherein a plurality of types of licenses for the content generation according to the context information is issued, and
the processing unit performs processing for permitting or accepting the content generation according to all the licenses determined to be possessed by the device among the plurality of types of licenses.

9. The information processing apparatus according to claim 1, wherein the processing for permitting or accepting the content generation includes causing a display unit to display a display indicating that the content generation is permitted or accepted.

10. The information processing apparatus according to claim 1, wherein the processing for permitting or accepting the content generation includes causing a communication unit to transmit, to the device, information indicating that the content generation is permitted or accepted.

11. The information processing apparatus according to claim 1, wherein the context information is notified to the device at a location corresponding to the context information.

12. The information processing apparatus according to claim 11, wherein the context information is notified to the device in a case where a user carrying the device enters or exits from a location corresponding to the context information.

13. The information processing apparatus according to claim 1, further comprising
a second determination unit that determines whether or not the device is a valid device on a basis of a detection result of a signal transmitted by the device,
wherein, in a case where it is determined by the second determination unit that the device is not a valid device, the processing unit performs processing for prohibiting or restricting the content generation by the device.

14. The information processing apparatus according to claim 5,
wherein the device includes a sensor unit, and
the content is generated by the device on a basis of a sensing result by the sensor unit and the license.

15. The information processing apparatus according to claim 14,
wherein a sublicense is issued by a user of the device, and
the content is further generated by the device on a basis of the sublicense.

16. The information processing apparatus according to claim 15, wherein the content is generated by the sensing result by the sensor unit being encrypted by the device on a basis of the license and the sublicense.

17. The information processing apparatus according to claim 15, wherein a type of function permitted to the device related to the content generated by the device is determined on a basis of the license and the sublicense.

18. The information processing apparatus according to claim 17,
wherein the content generated by the device is transmitted by the device to a second device,
in a case where the second device has the license and the sublicense, execution of a function according to the license and the sublicense regarding the content is permitted to the second device, and
in a case where the second device does not have the license or the sublicense, execution of a function related to the content is not permitted to the second device.

19. An information processing method comprising:
acquiring context information of a device;
determining whether or not the device has a license for content generation according to the context information; and
performing, by a processor, processing for permitting or accepting the content generation by the device in a case where it is determined that the device has the license.

20. A program for causing a computer to function as:
an acquisition unit that acquires context information of a device;
a first determination unit that determines whether or not the device has a license for content generation according to the context information; and
a processing unit that performs processing for permitting or accepting the content generation by the device in a case where it is determined that the device has the license.
